(19) United States
(12) Patent Application Publication
(10) Pub. No.: US 2014/0304806 A1
(43) Pub. Date: Oct. 9, 2014

(54) SECURITY MEDIA AND AUTHENTICATION SYSTEM INCLUDING THE SAME

(71) Applicant: Hong-sik Koo, Yeongdeungpo-gu (KR)

(72) Inventor: Hong-sik Koo, Yeongdeungpo-gu (KR)

(73) Assignee: 3WAYTECHNOLOGY CO., LTD., Seoul (KR)

(21) Appl. No.: 14/343,346

(22) PCT Filed: Sep. 6, 2012
(86) PCT No.: PCT/KR2012/007200

§ 371 Date: Jun. 27, 2014

(30) Foreign Application Priority Data
Sep. 6, 2011 (KR) 10-2011-0090228
Jan. 30, 2012 (KR) 10-2012-0009223
Feb. 3, 2012 (KR) 10-2012-0011442

(51) Int. Cl. G06F 21/31

(52) U.S. Cl. CPC G06F 21/31
USPC 726/16

(57) ABSTRACT

Disclosed is a security media which can increase a user's convenience without needing for the user to directly input a security code to a touch screen. The security media includes a plate and a plurality of conductive patches adhered to the plate. The plurality of conductive patches may be arranged as a pattern, and thus, when the plurality of conductive patches touch a touch screen of a target device, the pattern may be used as a code for authentication or control of the target device.

### TECHNICAL FIELD

The present invention relates to a security media and an authentication system including the same, and more particularly, to a security media and an authentication system including the same, which authenticate or identify a user.

### BACKGROUND ART

As it is simple and easy to use, the touch screen which is a type of input device that reads data from input media for communicating with devices or equipment has been being more widely used. Touch screens fall into three categories of technology: Resistive, capacitive and surface acoustic wave (SAW) according to a method of sensing touch. The surface acoustic wave or SAW technology that uses ultrasonic wave that passes over touch panel to detect (sense) a touch is been being applied to touch-enabled devices recently.

Resistive sensing technology uses several layers on the panel among which two thin, transparent electrically resistive layers separated by a thin space play a role of sensing a touch. When an object such as fingertip, stylus pen presses down onto the outer surface of the panel, the two layers touch to become connected and the position of the pressure may be read.

Contrary to the resistive sensing, capacitive sensing technology uses a glass coated with a transparent conductor as a sensing media. As the human body is also an electrical conductor, touching the surface of the screen causes a change in capacitance by which the touch panel may sense a touch.

In comparison with the screen with resistive sensing technology, the capacitance screen panel may be built approximately 1 mm thinner and avoid sensing touches by the unwanted external pressure while providing multiple simultaneous touches or gestures such as swipe, scroll or pinch-stretch to zoom. For this reason, touch screens with capacitance panel are now preferred to the others.

Surface acoustic wave (SAW) technology uses ultrasonic waves that pass over the touchscreen panel to sense touches by detecting the change of ultrasonic waves. Because surface acoustic wave technology is free from blind area, it provides steady sensitivity of touch, while contaminants on the surface may also interfere with the functionality of the touchscreen.

It is common that users of computers with touch screen, smart phone, banking or personal IT devices authenticate by touching fingers on the software keyboard or geometric figures when entering the password or code.

In the authentication process mentioned above, it is inconvenient that users have to memorize his or her authentication code. It is also annoying for users to enter a long password by touching fingers on the screen and poses security issues of vulnerability and exposure. This is serious especially when a user uses same code not to forget it for multiple authentications.

### DISCLOSURE

### Technical Problem

One aspect of the present invention is directed to provide a security media and an authentication system including the same, which authenticate a user without the user's memorizing a password or authentication code of the user.

Another aspect of the present invention is directed to provide a security media and an authentication system including the same, which enable a pattern to be easily and accurately input to a touch screen of a target device.

The other aspect of the present invention is directed to provide a security media and an authentication system including the same, which simply perform a variety of complicated authentication procedures.

### Technical Solution

To achieve these and other advantages and in accordance with the purpose of the invention, as embodied and broadly described herein, there is provided a security media including: a plate; and a plurality of conductive patches adhered to the plate.

The plurality of conductive patches may be arranged as a pattern, and thus, when the plurality of conductive patches touch a touch screen of a target device, the pattern may be used as a code for authentication or control of the target device.

In another aspect of the present invention, there is provided an authentication system including: a security media configured to include a plurality of conductive patches formed of a material having a predetermined capacitance or resistance; and a target device configured to, when the security media touches a touch screen, sense the plurality of conductive patches, generate a code corresponding to touch points at which the plurality of conductive patches are respectively sensed on the touch screen, and perform authentication or control.

### Advantageous Effects

According to the present invention, users don't need to memorize authentication code because an authentication is performed automatically by simply letting the security media touch the input area on the target device.

Since the authentication using the security media requires no manual input by the user, it leaves no fingerprints or scratches on the surface and thus, free from the security issue of visually exposing the authentication code.

Moreover, the present invention may apply multiple patterns for a single authentication, and thus secures the authentication code from being exposed in multiple layers.

According to the present invention, when the security media is designed for credit card embedding IC, the security media may be used as both a credit card and an authentication device.

### DESCRIPTION OF DRAWINGS

FIG. 1 is a view schematically showing an authentication system according to an embodiment of the present invention.

FIG. 2 is a view showing a security media according to a first embodiment of the present invention.

FIGS. 3 and 4 show a variation example of the security media of FIG. 2.

FIG. 5 is a view showing a security media according to a second embodiment of the present invention.

FIG. 6 is a view showing a security media according to a third embodiment of the present invention.

FIGS. 7 and 8 show a variation example of the security media of FIG. 6.

FIG. 9 is a view showing a security media according to a fourth embodiment of the present invention.

FIG. 10 shows a variation example of the security media of FIG. 9.

FIG. 11 is a view showing a security media according to a fifth embodiment of the present invention.

FIG. 12 shows a variation example of the security media of FIG. 11.

FIG. 13 is a view showing a security media according to a sixth embodiment of the present invention.

FIG. 14 shows a variation example of the security media of FIG. 13.

FIG. 15 is a view showing an example of a security media integrated with a credit card.

FIG. 16 is a cross-sectional view of FIG. 15.

FIG. 17 is a block diagram schematically showing a target device according to an embodiment of the present invention.

FIG. 18 is a view schematically showing a guide pattern according to an embodiment of the present invention.

### MODE FOR INVENTION

Hereinafter, embodiments of the present invention will be described in detail with reference to the accompanying drawings.

In the accompanying drawings, a portion irrelevant to a description of the present invention will be omitted for clarity. Like reference numerals refer to like elements throughout.

The terms described in the specification should be understood as follows.

Terms like a first and a second may be used to describe various elements, but the elements should not be limited by the terms. The terms may be used only as object for distinguishing an element from another element. For example, without departing from the spirit and scope of the inventive concept, a first element may be referred to as a second element, and similarly, the second element may be referred to as the first element.

In the following description, the technical terms are used only for explaining a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

FIG. 1 is a view schematically showing an authentication system 100 according to an embodiment of the present invention.

Referring to FIG. 1, the authentication system 100 includes a security media and a target device 120.

The security media 110 inputs a pattern composed of conductive patches to the target device. The conductive patches may accommodate a critical level of capacitance or may be provided with capacitance from an external source. When the conductive patch touches a touch screen of the target device 120, the conductive patch is electrically connected to the touch screen, and is recognized by the target device 120.

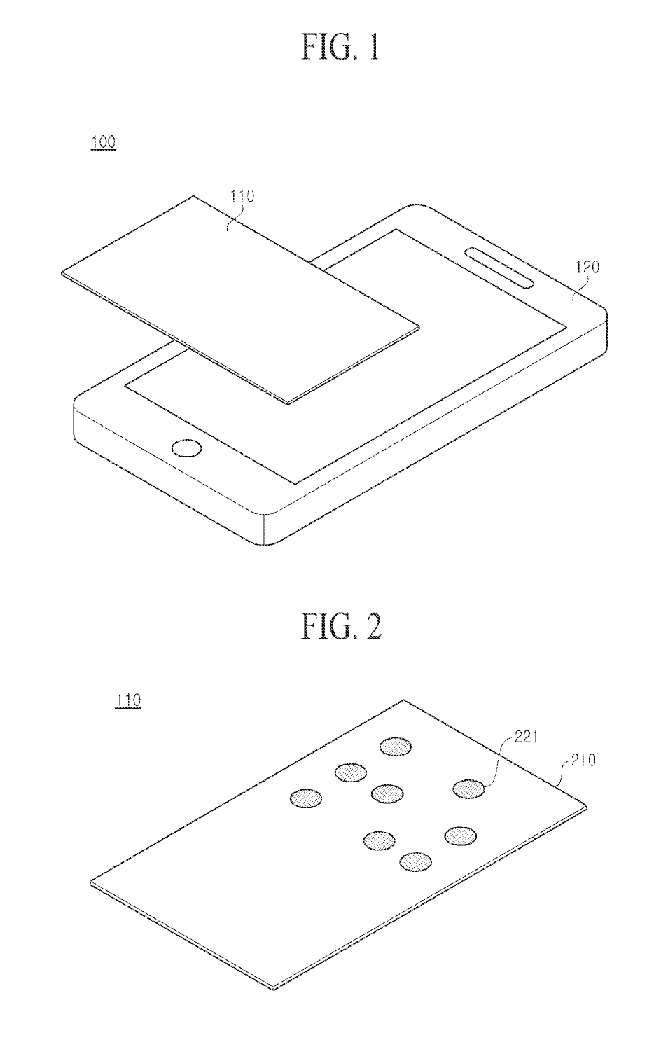

Hereinafter, the security media 110 will be described in more detail with reference to FIGS. 2 to 7.

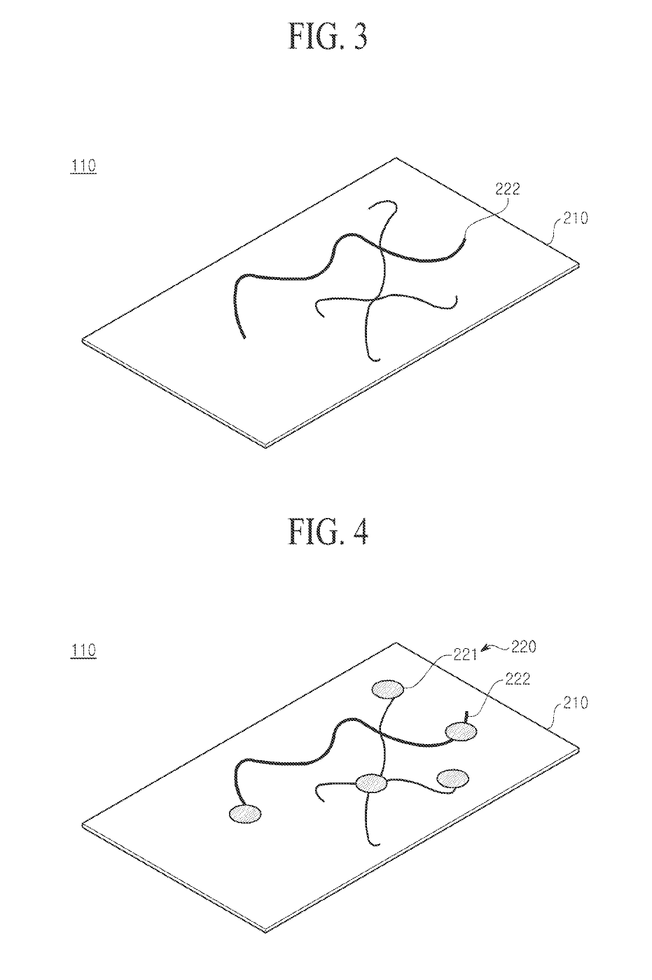

FIG. 2 is a view showing a security media 110 according to a first embodiment of the present invention. FIG. 3 and FIG. 4 show a variation example of the security media of FIG. 2.

Referring to FIG. 2, the security media 110 includes a plate 210 and a plurality of conductive patches 220.

The plate 210 configures a body of the security media 110. The plate 210 may be formed of non-conductive material such as plastic, wood, rubber or paper.

In an embodiment, the plate 210 may be implemented with a card. In order for the security media to be accommodated in a user's wallet, the plate 210 may have a thin thickness, and may be implemented in a variety of shapes such as square, triangle, circle or oval.

In another embodiment, the plate 210 may be formed of a soft sheet. In this case, an adhesive surface of the plate 210 may be formed so that the adhesive surface is attached onto a side of stamp, name card or character product.

The conductive patch 220 is formed of a conductive material on the plate 210. The conductive patch 220 may charge or discharge, and may be formed of conductor, semi-conductor, semi-conductive material unit or a combination of semi-conductive material unit.

The conductive patch 220 may have a critical level of capacitance. The critical level represents the minimum level of capacitance that the touch screen may sense the position of a touch.

The conductive patch 220 may have a shape of at least a polygon, a circle or a line. As shown in FIG. 2, for example, patches having the shape of circle (221, hereafter referred to as circular patch) are disposed on the plate 210 of the security media 110. Patches in the shape of line (222, hereafter referred to as linear patch), as shown in FIG. 3, may also be disposed on the plate 210 of the security media 110. Alternatively, as shown in FIG. 4, a combination of circular patches 221 and linear patches 222 may be disposed on the plate 210 of the security media 110, wherein the linear patch 222 may be connected to multiple circular patches 221.

A thickness of the conductive patch 220 is not limited, and the conductive patch 220 may be thinly printed on the plate 210.

The conductive patches 220 form a pattern which is used as a code for authenticating user. The code may correspond to various pieces of data such as social security number, driver's license number, health insurance registration number, card number, user ID, password or message.

In an embodiment, different patterns may be applied depending on users. For example, banking institutions have to issue the security media with a unique pattern embedded to each of their customers for transaction security. In this case, each security media for the customer should have a unique pattern.

In another embodiment, different patterns may be applied depending on services. For example, a web service provider may need to assign a unique pattern to users by a specific web service to uniquely identify users visiting the specific web service. In this case, users of a specific web service or web URL have same pattern, but different from users of a different web service or web URL.

In an embodiment, the conductive patches 220 are attachable or detachable. Users may implement a pattern by detaching or attaching at least one of the conductive patches.

As a detailed example, the plate 210 of the security media 110 covered with a protective film has cavities with conductive patches 220, and a user may remove the film and take one or more conductive patches 220 out from the plate 210 to build its own pattern. Then, the user may cover the film again having the security media 110 with a private pattern.

In another example, when the conductive patches 220 are attached to the plate 210 of the security media 110, a user may build its own pattern by detaching one or more conductive patches 220 from the plate 210.

In another example, when the security media is gotten for the first time, the conductive patches 220 may be attached to an initial region that is separately provided. A user may move and attach the conductive patches 220 (which are attached to the initial region) to a specific position so as to match a unique pattern allocated to the user. Therefore, a general-use security media may be changed to the security media 110 of the user.

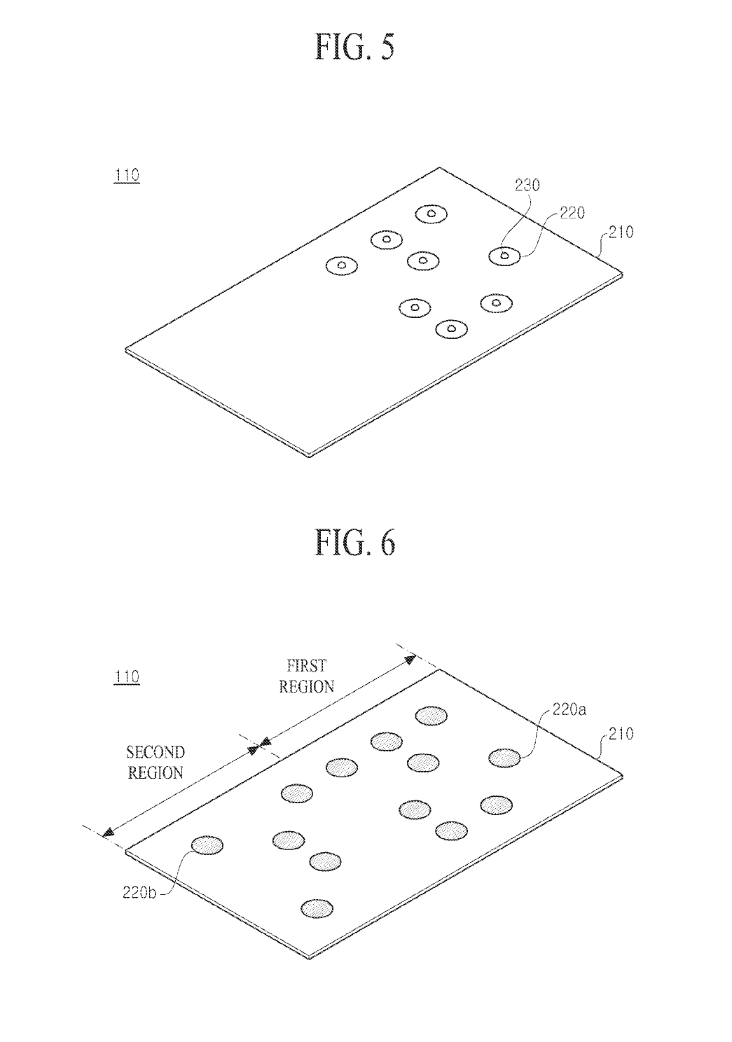

FIG. 5 is a view showing a security media 110 according to a second embodiment of the present invention.

The security media 110 according to the second embodiment of the present invention further include projections 230 in comparison with the security media 110 of FIG. 2. The other elements are the same.

When the projection 230 touches the touch screen of the target device 120, the projection 230 electrically connects the conductive patch 220 to the touch screen. The target device 120 may sense a pattern (which is composed of the conductive patches 220) through the projections 230 and then performs authentication by using the pattern.

The projection 230 may have a certain height so that a certain area of the security media 110 touches the touch screen of the target device 120. Here, the certain area denotes a minimum of area for sensing a touched position of the touch screen.

Recently, it has been popular that the target device 120 uses the protective case to protect it from an external shock. In this case, because of the difference of height between the protective case and the touch screen, users have to apply pressure to get the security media 110 touch the screen. Moreover, it may be unable for the security media to even touch the screen or result in a false sensing of the pattern.

The projection 230 is for resolving the issue mentioned above by allowing it to be higher than the difference of the height between the protective case and the touch screen.

The security media 110 of FIGS. 2 to 5 includes one pattern, but is not limited thereto. As another example, the security media 110 may include a plurality of patterns. Hereinafter, a security pattern 110 with a plurality of patterns formed therein will be described in detail with reference to FIGS. 6 to 8.

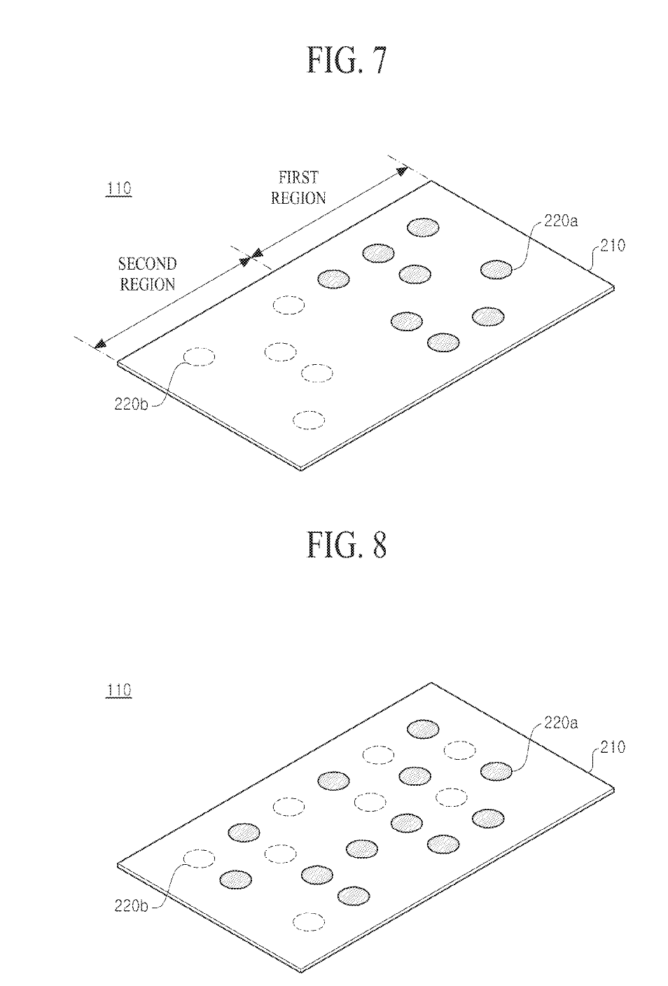

FIG. 6 is a view showing a security media according to a third embodiment of the present invention. FIG. 7 and FIG. 8 show a variation example of the security media of FIG. 6.

The security media 110 shown in FIG. 6 to FIG. 8 includes two patterns. However, this is for the brevity of the illustration and does not mean that the security media 110 may not have three or more patterns. For the same reason, the following description uses the circular patch 221 for the conductive patch 220 and should be these two terminologies should be considered interchangeable.

In comparison with the security media 110 of FIG. 2, the security media 110 of FIG. 6 includes a first conductive path 220a and a second conductive patch 220b.

The first conductive patch 220a and the second conductive patch 220b may be formed of a conductive material on the plate 210.

In an embodiment, the first conductive patch 220a and the second conductive patch 220b may be disposed on the same plane. In this case, as shown in FIG. 6, a first region with the first conductive patches 220a formed therein may not overlap a second region with the second conductive patches 220b formed therein.

In another embodiment, the first conductive patch 220a and the second conductive patch 220b are disposed on different planes. In this case, the first area where the first conductive patches 220a are disposed and the second region where the second conductive patches 220b are disposed may be separate as shown in FIG. 7 or may be overlapped as shown in FIG. 8, but not on the same plane.

The first conductive patches 220a compose a first pattern which is used for a primary user authentication code. The second conductive patches 220b compose a second pattern which is used as a secondary user authentication code.

Both the first and the second pattern of the above may be applied to the same service. For example, the first and the second pattern may be used as the first code and the second code for bank transactions where a user has to authenticate primary code as well as second code.

The first and second patterns may be applied to a sequence of service. For example, the first pattern is used to unlock the phone then, the second pattern is used to bring up a phone-call or other data service.

As another example, the first pattern may be used as a primary code for visiting a website and the second pattern for accessing a specific service of that website. The website, in this case, represents a website that allows access from a specific group of users, and the specific service represents a service that is allowed to the users with appropriate access authority.

The security media 110 may further include additional capacitive units for providing the conductive patches 220 with a critical level of capacitance. Hereinafter, the capacitive units provided in the security media 110 will be described in detail with reference to FIG. 5.

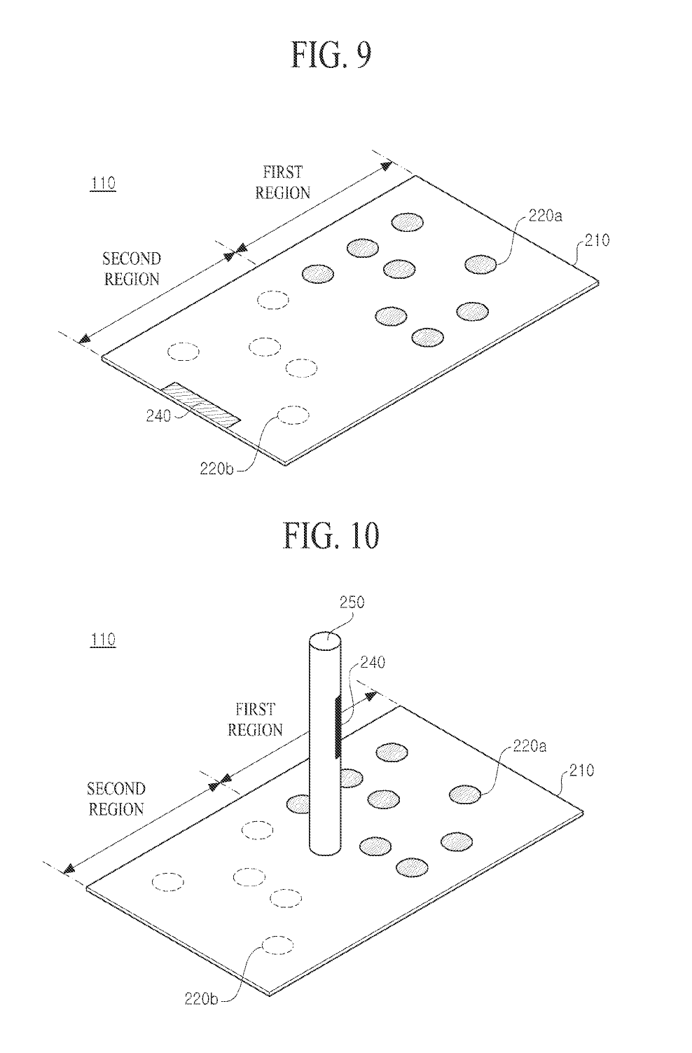

FIG. 9 is a view showing a security media 110 according to a fourth embodiment of the present invention. FIG. 10 shows a variation example of the security media of FIG. 9.

In comparison with the above-described security media, the security media 110 according to the fourth embodiment of the present invention may further include a capacitive unit 240.

The capacitive unit 240 is formed of a capacitive material, which is electrically connected with the conductive patches 220. The capacitive unit 240 may be formed of conductive copperplate, semi-conductor, a combination of conductive elements and non-conductive elements, a combination of resistive elements or other elements.

The capacitive unit 240 allows the critical level of capacitance to be generated in the conductive patches 220. The critical level of capacitance represents the minimum capacitance which enables the touch screen to sense a touch.

In an embodiment, the capacitive unit 240 itself may have a critical capacitance. In this case, the capacitive unit 240 may supply an electric charge to the conductive patch 220 having a capacitance less than a critical level, thereby allowing the conductive patch 220 to have the critical level of capacitance.

In another embodiment, the capacitive unit 240 may function as a ground. That is, the capacitive unit 240 may provide a path for the electric current between the touch screen and the outside when the security media 110 touches the screen.

The capacitive unit 240, as shown in FIG. 9, may be formed on one side of the plate 210, and may be electrically connected with the conductive patches 220.

In an embodiment, the capacitive unit 240 may be electrically connected with the conductive patches 220 by the electric lines in the first direction and the second direction. In this case, the conductive patches 220 may be placed at the intersection of the electric lines in the first direction and the second direction. The electric lines mentioned above, may be printed on the plate 210 in the form of a grid, a rectangular edges combined in a comb structure, or irregular combinations of streamlines.

In another embodiment, the capacitive unit 240 may be electrically wired (connected) with the conductive patches 220 by the conductive material embedded on the edges of the plate 210. More specifically, the capacitive unit 240 may be electrically connected with the conductive patches 220 by having the electric lines wiring the conductive patches 220 connect to the edges of the plate 210. As the edges of the plate, in this case, are to be formed of conductive material, they may make the security media look luxurious when they have metallic gloss. In addition, if the edges are formed of high strength metallic conductive material, they may protect the frame of the plate 210.

In another embodiment, the capacitive unit 240 and the conductive patches 220 may be wired by a single electric line. For example, a single electric line may be embedded along with the columns of the conductive patches 220 and the capacitive unit 240 may be wired to one end of it.

On the other hand, as shown in FIG. 10, the capacitive unit 240 may be formed on a side of a stylus pen 250 in combination with the stylus pen 250.

The stylus pen 250 may include a conductive material electrically connected with the capacitive unit 240, and expose the conductive material to touch the security media 110. The stylus pen 250 may establish an electric connection by touching the exposed conductive material (surface) to the touch hole on the plate 210.

Although not shown in FIGS. 9 and 10, the capacitive unit 240 may include a first capacitive unit electrically connected with the first conductive patches 220a and a second capacitive unit electrically connected with the second conductive patches 220b.

In an embodiment, the first conductive patch 220a may be the capacitive unit 240, and may allow a critical level of capacitance to be generated in the second conductive patches 220b. The second conductive patch 220b may be the capacitive unit 240, and may allow a critical level of capacitance to be generated in the first conductive patches 220a.

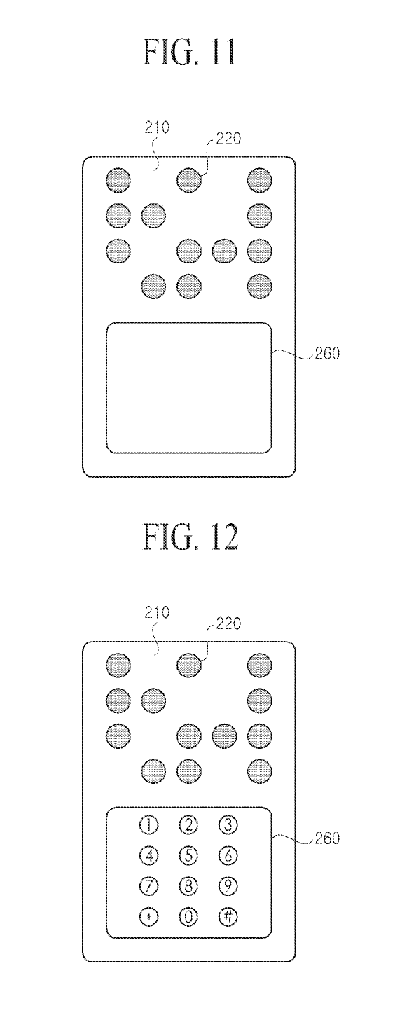

In addition to the conductive patches 220 mentioned above, the security media 110 may include an additional input pad for self-reading authentication code from users. Hereinafter, a pad formed in the security media 110 will be described in detail with reference to FIGS. 11 and 12.

FIG. 11 is a view showing a security media 110 according to a fifth embodiment of the present invention. FIG. 12 shows a variation example of the security media of FIG. 11.

The security media 110 according to the fifth embodiment of the present invention may further include a pad 260 in comparison with the security media 110 of FIG. 2. The other elements are the same.

The security media 110 according to the fifth embodiment of the present invention has a transparent or a translucent pad 260 for users to see through which the numbers or other characters displayed in the screen of the target device. For instance, the touch screen of the target device may display numeric and “*”, “a” characters.

It is desirable that the material and thickness of the pad 260 do not interrupt the flow of electric current. This is because users may enter the third code by touching fingers on the pad (260) according to the numbers or other characters seen through from the touch screen of the target device 120 onto which the security media 110 is placed (touched).

In the pad 260, as shown in FIG. 6, multiple numbers or characters may be printed to guide users to touch predefined positions. For instance, users may input the third code into the target device 120 by touching numbers or other characters by referencing them printed on the pad 260.

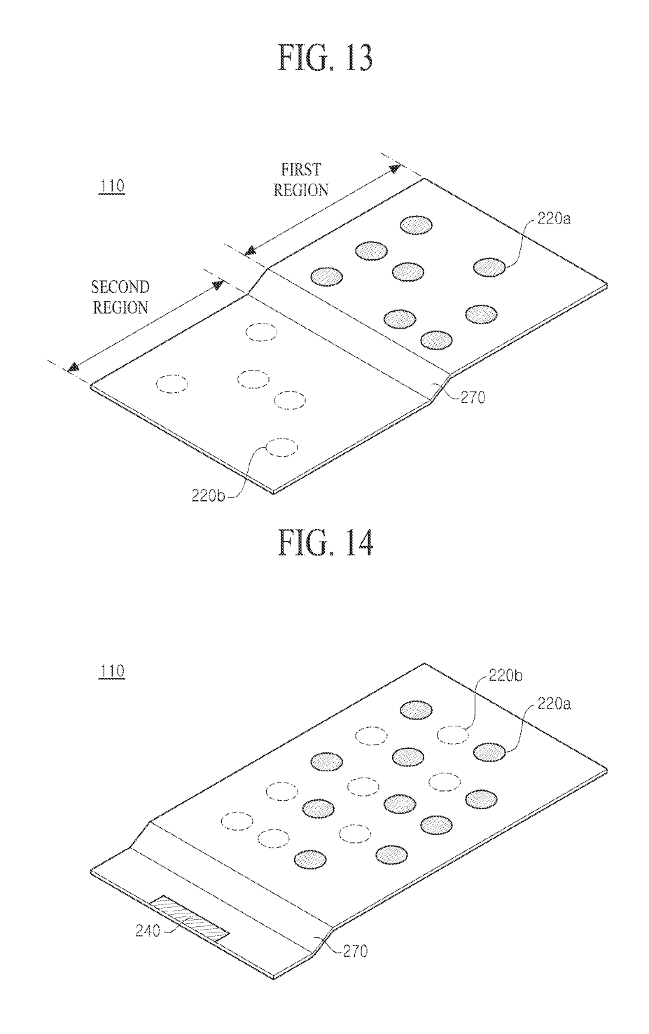

The security media 110 may further include a bending part (hinge) for a user's convenience. Hereinafter, the bending part formed in the security media 110 will be described in detail with reference to FIGS. 13 and 14.

FIG. 13 is a view showing a security media according to a sixth embodiment of the present invention. FIG. 14 shows a variation example of the security media of FIG. 13.

The security media 110 according to the sixth embodiment of the present invention may further include a bending part 270 in comparison with the above-described security media.

The bending part 270 may be provided between a first region with a first pattern formed therein and a second region with a second pattern formed therein, and may have various shapes such as a U-shape, a V-shape, an L-shape or a stepped shape. In an embodiment, the bending part 270 may have a dented groove on at least one of the two sides of the plate, so that users form a bend shape for themselves. For example, users may bend or spread out the plate by applying a pressure along the dented groove.

Due to the bending part 270, the first region may be formed relatively higher or lower than the second region. For example, when the first pattern is input in the target device, the first region contacting the touch screen may be formed lower than the second region that does not contact the touch screen.

Moreover, the bending part 270 may have a certain height so that a certain area of the security media 110 touches the touch screen of the target device. Here, the certain area denotes a minimum of area for sensing a touched position of the touch screen.

Recently, it has been popular that the target device 120 uses the protective case to protect it from an external shock. And, in this case, there exists a difference (a gap) of height between the edges of the protective case and the surface of the touch screen. To provide a secure contact, the bending part 270 may be provided to be higher than the difference of the height between the edges of the case and the surface of the touch screen.

In the embodiment of FIG. 13, a security media with two patterns formed therein is described, but is not limited thereto. In another embodiment, the security media 110 may include one pattern. In another embodiment, the security media 110 may include three or more patterns.

For example, when the security media 110 includes three patterns, the security pattern 110 may include a first region with a first pattern formed therein, a second region with a second pattern formed therein, and a third region with a third pattern formed therein. The security media 110 may further include a first bending part, which is provided between the first and second regions, and a second bending part which is provided between the second and third regions.

The bending part 270 of the security media 110 shown in FIG. 14, unlike that of the security media shown in FIG. 13, may be disposed between a touch area and a non-touch area. The touch area, in this case, represents the area containing the first and the second region. On the other hand, the non-touch area represents the area that occupies neither the first region nor the second region.

The bending part 270, as shown in FIG. 13, may have a dented groove either on the first surface or the second surface for users to bend the plate. For example, users may bend or spread out the plate by applying a pressure along the dented groove.

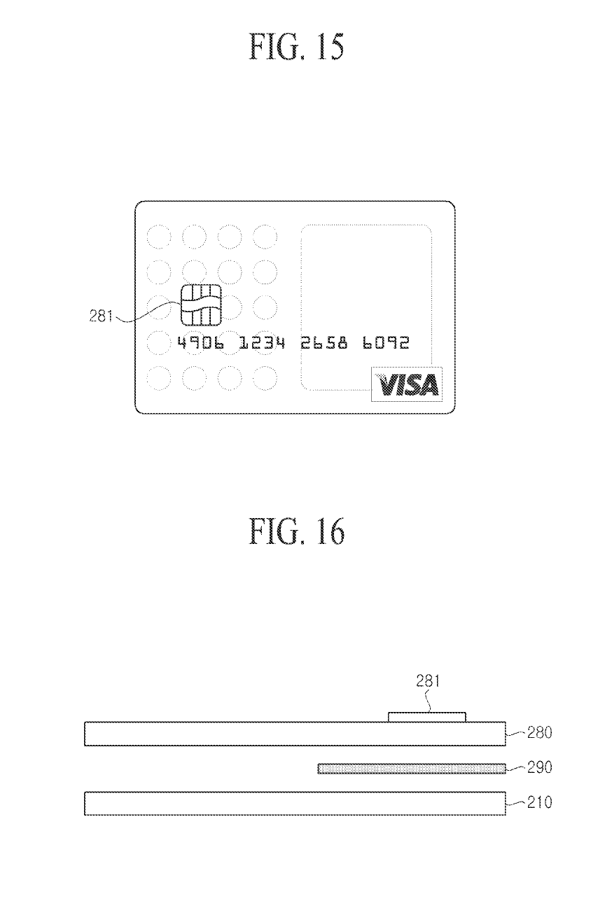

The security media 110 mentioned above may be integrated with a banking card. Hereinafter, the security media 110 integrated with a banking card will be described in detail with reference to FIGS. 15 and 16.

FIG. 15 is a view showing an example of a security media integrated with a credit card. FIG. 16 is a cross-sectional view of FIG. 15.

Here, the banking card represents a generic term for a card type media that performs banking transactions or authentications using an IC chip 281 such as a credit card, check card, a debit card, a cash card, an electronic passbook, a transportation card, an electronic employee card, an electronic student id card or an electronic personal ID card.

The IC 281 where personal financial information and/or identification are stored is attached to one side of the security media 110, and at least one of the information such as card number, valid date, holder name, issuing organization, brand name, photo of holder is printed or raised printed, according to the type of the banking card.

Since the IC chip 281 of the banking card 280 is conductive, electronic interference can occur between the IC chip 281 and the conductive patches 220 of the security media 110. For this reason, an additional insulating layer 290 may be stacked between the pate 210 of the security media 110 and the banking card 280 when gluing these together. The insulating layer 290 may be wide enough to cover the IC chip 281.

However, since the banking cards 280 are formed of non-conductive material, the additional insulating layer 290 may not be necessary when the electronic interference is negligible. The IC chip 281, in this case, may be disposed in an area which avoids overlapping with the conductive patches 220.

The security media 110 illustrated in FIG. 15 is integrated with a banking card, but the security media 110 may be integrated with a name card in other use case. In this case information like a photo of the holder, address, contact number, company name the holder belongs to may be printed on it.

In FIGS. 2 to 16, it has been described above that the security media 110 applied to the capacitive touch screen has been described above. However, the security media 110 that is proposed in the present invention may be applied to the resistive touch screen as well. To this end, the security media 110 may have pressure projections (not shown) instead of the conductive patches 220.

In this case, pressure projections (not shown) may be implemented to press coordinates on the touch screen by having the wider area fixed towards the plate 210 in a truncated-cone shape or a semi-spherical shape.

The pressure projections (not shown), as in the conductive patches 220 described above, have different patterns by user. The pattern may be used as a user authentication code when the security media 110 touches the touch screen of the target device 120.

Referring again to FIG. 1, the target device 120 performs authentication by analyzing the pattern sensed by the security media 110.

The target device 120 is a generic term for a device with a touch screen, more specifically, a desktop computer, laptop computer, a Personal Digital Assistant, a mobile/smart phone, Automatic Teller Machine, a digital safe, a digital door lock or an electronic kiosk etc.

Here, the touch screen mentioned above includes a touch screen integrated with a tempered glass unit underneath the touch unit, a touch screen with a touch unit attached on top of a display unit, or an In-Cell touch screen implementing a touch sensor inside the display cell which is composed of color filter, lcd and thin film transistor.

That is, examples of the target device 120 according to the present invention may include all devices that sense an electrical change that occurs when a conductor touches the touch screen, and detect a touched region.

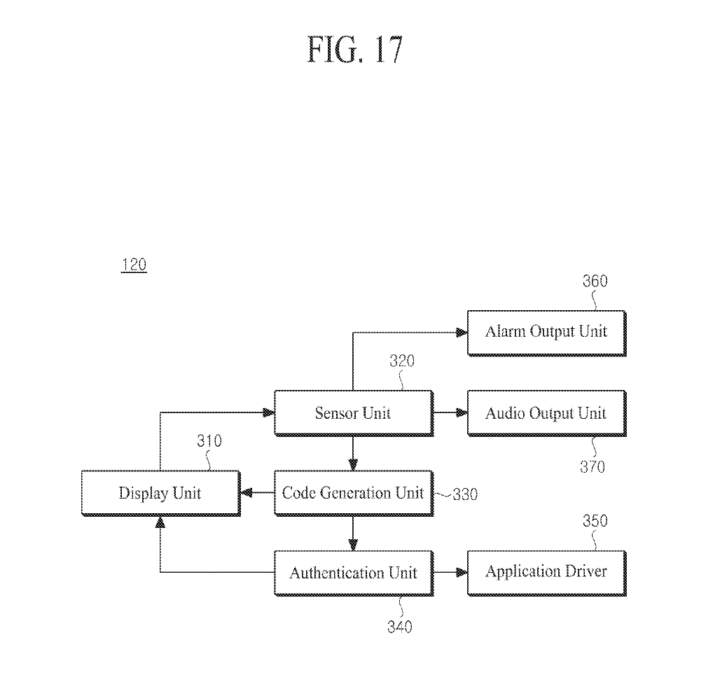

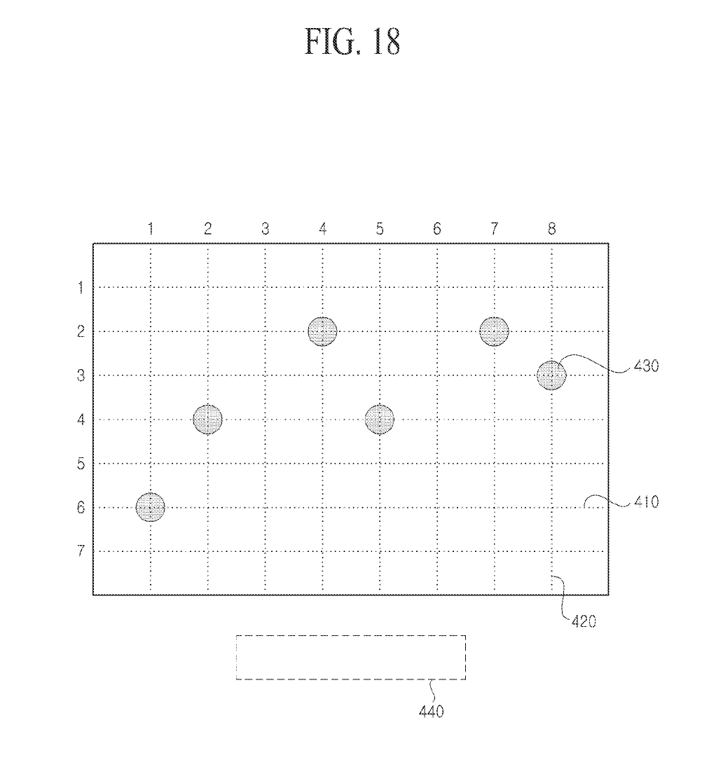

FIG. 17 is a block diagram schematically showing a target device according to an embodiment of the present invention. FIG. 18 is a view schematically showing a guide pattern according to an embodiment of the present invention.

As shown in FIG. 17, the target device 120 includes a display unit 310, a sensor unit 320, a code generation unit 330, and an authentication unit 340. In an embodiment, the target device 120 may include at least one of an application driver 350, an alarm output unit 360, and an audio output unit 370.

The display unit 310 displays a reference pattern (a guide line) on the touch screen. Here, the reference pattern acts as a guide line when a user inputs a touch pattern.

As illustrated in FIG. 18, the guide lines includes a plurality of the first guide lines 410 and a plurality of the second guide lines 420 intersecting the first guide lines 410. The first guide lines 410, in this case, may represent an X axis, and the second guide lines 420 represent a Y axis. In addition, an intersecting point between the first guide line 410 and the second guide line 420 may be represented as 2D coordinates having X and Y values.

In the embodiment of FIG. 18, both X and Y axes are represented as numeric values. However, the values may include at least one or more of numbers, alphabets or symbols. In another embodiment, a plurality of the first guide lines 410 may represent musical scales while representing octaves by a plurality of the second guide lines 420. And the intersections between the first guide lines 410 and the second guide lines 420 may represent a specific note of a scale.

Moreover, the display unit 310 may further display a code display window 440 on the touch screen. The code display window 440 is for displaying a code generated by the code generation unit 330, and may be displayed as an empty space in an initial stage of authentication.

When the guide lines are displayed on the touch screen, the display unit 310 provides the authentication unit 340 with information about the guide lines. The information includes position information of each of the first guide lines 410, the second guide lines 420, and the intersecting points (coordinates).

Subsequently, the sensor unit 320 receives a pattern from the security media 110. When the conductive patches 220 of the security media 110 touch the touch screen, the sensor unit 320 senses the position of the conductive patches 220. The positions sensed by the sensor unit 320 forms a pattern. In one use case, the sensor unit 320 may sense a touch group, consisting of one or more touch patterns, at certain intervals. In this case, touch patterns sensed within a first interval may be recognized as being included in the same touch group, and touch patterns sensed after the first interval may be recognized as being included in a different touch group.

For example, when it is assumed that the target device 120 performs an authentication by sensing a touch pattern composed of six touch points, the sensor unit 320 may sense the first touch group which consists of the six touch points.

As another example, the sensor unit 320 may sense the first touch group including a touch pattern with three touch points within the first interval, and sense the second touch group including a touch pattern with three touch points within the second interval. As another example, the sensor unit 320 may sense the first touch group including two touch points within the first interval, and sense the second touch group including two touch points within the second interval, and sense the third touch group including two touch points within the third interval.

The sensor unit 320 senses the touch points at the intersections of the guide lines. On the contrary, the sensor unit 320 may not sense a touch point not on an intersection.

When touch points are sensed, the sensor unit 320 obtains coordinates of the touch points, and then the coordinates of sensed touches are delivered to the code generation unit 320. For example, the coordinates of the six touch points illustrated in FIG. 18 may correspond to (2,4), (2,7), (3,8), (4,5), and (6,1). Subsequently, the code generation unit 330 generates a code corresponding to the coordinates of the touch points. In an embodiment, the code generation unit 330 may generate the code by using the coordinates of the touch points.

For example, when the coordinate of a touch point is (2,4), the code generation unit 330 may generate 24 as a code.

In another embodiment, the code generation unit 330 may generate a code using at least one numbers, alphabets or symbols that correspond to the coordinate. The target device 120 may further include a storage (not shown) that stores one or more numbers, alphabets, or symbols that correspond to the coordinates sensed.

For example, when the coordinate of a touch point is (2,4), the code generation unit 330 may search the storage (not shown) to find a code that matches the coordinate (2,4). When the code that matches the coordinate (2,4) is found, the code generation unit 330 may generate, as the code, B4 that matches (2,4).

When there are multiple touch groups consisting of one or more touch points, the code generation unit 330 may generate a sub-code by touch group. The code generation unit 330 may also generate a code that is comprised of multiple sub-codes, based on the time of the interval.

To describe a detailed example, it is assumed that three touch points sensed within the first interval compose a first touch group, and coordinates thereof are (2,4), (3,8), (6,1). Also, it is assumed that three touch points sensed within the second interval compose a second touch group, and coordinates thereof are (2,7), (4,2), (4,5). Here, the first interval is prior to the second interval, and does not overlap the second interval.

First, the code generation unit 330 may generate the first sub-code by using at least one of numbers, alphabets or symbols that correspond to the coordinates of the touch points in the first touch group. If the coordinates of (2,4), (3,8), (6,1) are correspond to B4, C8 and F1, the code generation unit 330 may generate “B4C8F1” as the first sub-code.

Subsequently, the code generation unit 330 may generate the second sub-code by using at least one of numbers, alphabets or symbols that correspond to the coordinates of the touch points in the second touch group. If the coordinates of (2,7), (4,2), (4,5) are correspond to B7, D2 and D5, the code generation unit 330 may generate “B7D2D5” as the second sub-code.

Finally, the code generation unit 330 may generate a code by using the first and second sub-codes. The code may include the first sub-code and the second sub-code, and an additional delimiter character between the sub-codes.

If the code uses the character, “-” as a delimiter, the code generation unit (330) may generate “B4C8F1-B7D2D5”.

The authentication unit 340 performs authentications with the code from the code generation unit 330. In detail, the authentication unit 340 performs authentications by comparing the code kept in the storage (not shown) with the code received from the code generation unit 330.

In an embodiment, the authentication unit 340 may display the code received from the code generation unit 330 through the display window 440, and thus, users of the security media 110 may check the code sensed by the target device 120.

In an embodiment, the authentication unit 340 provides the application driver 350 with an authentication result, thereby enabling the application driver 350 to drive a specific application requiring an authentication procedure. The application driver 350 displays the result of the application through the display window 310.

The alarm output unit 360 outputs an alarm if a conductive patch 220 touches the area other than the intersections. The alarm output unit 360 notifies a user of the security media 110 of touching a wrong area, and thus, the user may adjust the position of the security media 110.

The audio output unit 370 outputs an audio sound corresponding to the intersection of the guide lines when the conductive patch 220 touches the intersection. The first guide line 410 may represent a musical scale and the second guide line 420 may represent an octave. In addition, the intersections by the first guide lines 410 and the second guide lines 420 may represent notes of an octave.

In the above-described embodiments, the input of a touch pattern has been made using the security media 110. However, there is a problem that the authentication is not done by the target device 120 without the security media 110 because it was stolen, lost or because a user forgot to carry it.

The target device 120 of the present invention, as already described, reads a pattern from conductor 510 for authentication. Therefore, the target device may read a pattern from human fingers as well, because the human body is also conductive (a conductor). For this reason, in another embodiment, a stylus pen that includes a conductive material may be used for a pattern input.

The authentication system 100 described above uses the pattern from the security media 110 as an authentication code, but the use of the pattern does not need to be limited thereto.

The pattern may be used as the code to control the target device 120. Here, the code is a code corresponding to a command that commands the target device 120 to perform a specific operation.

To this end, the target device 120 may further include a control unit (not shown). The control unit (not shown) may control an operation of the target device 120 by using the code from the code generation unit 330.

More specifically, the target device 120 may have a touch screen and a multimedia unit that may play movie, cartoon, animation and computer game etc. The target device generates a code when the security media 110 touches the touch screen by sensing the conductive patches. Then, the target device 120 by sending the code to the control unit (not shown) by which, in turn, corresponding media content may be played.

The above-described security media or the function performed by the target device may be realized in a program command type executable in computers and stored in a computer-readable record medium. Herein, the computer-readable record medium may include a program command, a data file, and a data structure individually, or include the combination thereof. Furthermore, program commands stored in the record medium may be designed and constructed particularly for the present invention, or known to those skilled in computer software and usable.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A security media comprising:
a plate; and
a plurality of conductive patches adhered to the plate, and arranged as a pattern,
wherein when the plurality of conductive patches touch a touch screen of a target device, the pattern is used as a code for authentication or control of the target device.

2. The security media of claim 1, further comprising a capacitive unit formed of a conductive material, and configured to provide a capacitance equal to or greater than a critical value to the conductive patches,
wherein the capacitive unit is electrically connected with the conductive patches.

3. The security media of claim 1, wherein,
a plurality of first-direction electrical lines and a plurality of second-direction electrical lines are printed on the plate, and
the conductive patches are respectively arranged at intersection points between the plurality of first-direction electrical lines and the plurality of second-direction electrical lines.

4. The security media of claim 3, wherein the conductive patches are detachably arranged at the intersection points between the plurality of first-direction electrical lines and the plurality of second-direction electrical lines, respectively.

5. The security media of claim 1, wherein,
the conductive patches comprise:
a plurality of first conductive patches arranged as a first pattern on a first surface of the plate; and
a plurality of second conductive patches arranged as a second pattern on a second surface on the reverse of the first surface, and
the first pattern is used as a first code for authentication or control of the target device, and the second pattern is used as a second code for authentication or control of the target device.

6. The security media of claim 5, wherein,
the plurality of first conductive patches are provided in a first region of the plate, and
the plurality of second conductive patches are provided in a second region which does not overlap the first region.

7. The security media of claim 6, further comprising a bending part provided between the first region and the second region.

8. The security media of claim 1, further comprising a pad configured to directly receive a third code from a user through a touch, wherein the third code is used for authentication or control of the target device with the plate being laid over the touch screen of the target device.

9. The security media of claim 8, wherein a plurality of numbers or characters, which are used to guide a predetermined touch point to a user, are printed on the pad.

10. The security media of claim 8, wherein the pad is formed of a transparent material or a translucent material which passes through a plurality of numbers or characters, displayed on the touch screen of the target device, to enable a user to look at the plurality of numbers or characters.

11. The security media of claim 1, wherein,
the plurality of conductive patches are arranged on a first surface of the plate, and
a banking card with a built-in IC chip is integrated with a second surface on the reverse of the first surface.

12. The security media of claim 1, further comprising a plurality of projections respectively formed on the plurality of conductive patches.

13. An authentication system comprising:
a security media configured to include a plurality of conductive patches formed of a material having a predetermined capacitance or resistance; and
a target device configured to, when the security media touches a touch screen, sense the plurality of conductive patches, generate a code corresponding to touch points at which the plurality of conductive patches are respectively sensed on the touch screen, and perform authentication or control.

14. The authentication system of claim 13, wherein the target device acquires coordinates of the touch points, and generates the code by using the acquired coordinates.

15. The authentication system of claim 13, wherein the target device acquires coordinates of the touch points, and generates the code by using at least one of a number, a character, and a sign which match the acquired coordinates.

16. The authentication system of claim 13, wherein the target device senses a touch group consisting of one or more touch points at certain intervals, and generates a sub-code of the code for each of a plurality of the sensed touch groups.

17. The authentication system of claim 16, wherein,
touch points sensed within a first interval are recognized as being included in the first touch group, and
touch points sensed after the first interval are recognized as being included in a second touch group which is different the first touch group.

18. The authentication system of claim 13, wherein the target device displays a guide pattern, which includes at least one of a plurality of first guide lines and a plurality of second guide lines intersecting the plurality of first guide lines, on the touch screen.

19. The authentication system of claim 18, wherein the target device senses touch points which respectively touch intersection points between the plurality of first guide lines and the plurality of second guide lines.
